(19) United States
(12) Patent Application Publication
(10) Pub. No.: US 2023/0016353 A1
(43) Pub. Date: Jan. 19, 2023

(54) METHOD FOR VETTING A LEAD BASED UPON NUMERIC DATABASES

(71) Applicant: MegaBit, LLC, Hockessin, DE (US)

(72) Inventor: James D. Joyner, St. Louis, MO (US)

(73) Assignee: MegaBit, LLC, Hockessin, DE (US)

(21) Appl. No.: 17/868,659

(22) Filed: Jul. 19, 2022

Related U.S. Application Data
(60) Provisional application No. 63/223,269, filed on Jul. 19, 2021.
(60) Provisional application No. 63/239,476, filed on Sep. 1, 2021.

(51) Int. Cl. G06Q 10/10

(52) U.S. Cl. CPC G06Q 10/1053

(57) ABSTRACT

The collection and submission of data elements of phone number and zip or postal code starts with a software application that initiates an automated lead vetting process that will then automatically vet an individual associated with the request and gather details of the request itself from the requester, with this request. The automated lead vetting process performs computerized queries to ancillary, external data sources and requests additional information from the lead requester to verify an identity, validate the information, and add details to the request that is then provided to the business. The method to submit a lead to the software application utilizes manual data entry to software application interface, external website submitting data that is pointed to the software application, or with a direct data entry routed from outside, third party lead systems to the software application.

### CROSS-REFERENCE TO RELEATED APPLICATIONS

This non provisional application claims priority to provisional application Ser. No. 63/223,269 filed on Jul. 19, 2021 and provisional application Ser. No. 63/239,476 filed on Sep. 1, 2021 which have a common inventor.

### BACKGROUND OF THE INVENTION

The present invention relates to a method for an automated vetting process that utilizes the data entry of a single phone number and zip/postal code submitted from a web enabled, mobile-device or through a direct, electronic data integration to the system. Currently, vetting a sales lead is an overly time-consuming process for businesses. Representatives receive a lead call, email, text, or voicemail message and then must manually reply and manage the communication back to the individual who made the request. If the individual does not answer the phone, email, or text message quickly or at all, there will be additional, unnecessary time constraints added to this already slow process. Once the representative is in contact with the individual, the time to discuss, text, or email can turn into hours all without a guarantee of a sale. In addition, businesses need to shorten the time it takes to respond to and begin the lead vetting process from the initial lead inquiry in order to increase the likelihood of continuing with and converting the lead to an actual sale. This invention will address these issues with technological automations and artificial intelligence as a means of receiving, responding to, requesting, and processing the lead.

### DESCRIPTION OF THE PRIOR ART

The prior art to this invention only passes entered lead information to the business and does not address automating the process of inquiry and collaborating with individuals to gather information to convert the lead to a sale. After requesting information, the prior art does not request and process information, lookup and use ancillary data sources to calculate, interact with, and assist with the decision process for both the potential customer and the business.

### SUMMARY OF THE INVENTION

The collection and submission of data elements of phone number and zip/postal code start with a software application that starts an automated lead vetting process that will then automatically vet the individual associated with the request and gather details of the request itself from the requester, with this request. The automated lead vetting process performs computerized queries to ancillary, external data sources and requests additional information from the lead requester to verify identity, validate the information, and add details to the request that is then provided to the business. The method by which the lead can be submitted to the software application is by manual data entry to software application interface, external website submitting data that is pointed to the software application, or with a direct data entry that is routed from outside, third party lead systems to the software application.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved Method for Vetting a Lead Based Upon Numeric Databases that will automatically communicate with and analyze the potential customer and his request details to convert the lead to a sale.

Still another object of the present invention is to provide a new and improved method for vetting a lead based upon numeric databases that may be easily and efficiently manufactured and marketed to the consuming public.

Still another object of the present invention is to provide a method for vetting a lead based upon numeric databases that is a combination of automated/manual functionalities: simple entry process to start automated process.

Still another object of the present invention is to provide a method for vetting a lead based upon numeric databases that is a process of aggregating leads from outside lead sources to this invention. this invention will assign a unique, programmatically created, email address and phone number when the customer signs up for this invention. the user is then instructed to copy and update the pre-assigned email and phone number to the outside service account settings area. leads generated from outside lead sources will now be routed to this invention.

Still another object of the present invention is to provide a method for vetting a lead based upon numeric databases that is to help the business or individual automatically vet leads. the definition of a lead is subject to any business or individual that needs to automate the process of looking up information or communicating with the individual who submitted the lead.

Still another object of the present invention is to provide a method for vetting a lead based upon numeric databases with a quality score calculated and used to rate the lead. data verification steps are performed throughout the application vetting process. various forms of data analysis are performed to automatically vet the quality of the lead through querying ancillary data sources, collecting data input, interacting with, and reading behavioral events from the user. the quality of the lead refers to the results from all data analysis of the lead and the user.

Still another object of the present invention is to provide a method for vetting a lead based upon numeric databases is a two-way vetting process—this allows customers to see business owners' profiles and start the vetting process on their own.

Still another object of the present invention is to provide a Method for Vetting a Lead Based Upon Numeric Databases that may be clearly marketed and readily delivered to the subscribing users.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

In referring to the drawings,

FIG. 1 is a flow chart describing the preferred embodiment of the present invention;

FIG. 2 is a flow chart further describing the preferred embodiment of the present invention the invention after FIG. 1;

FIG. 3 is a flow chart further describing the preferred embodiment of the present invention the invention after FIG. 2; and

FIG. 4 is a flow chart further describing the preferred embodiment of the present invention the invention after FIG. 3.

The same reference numerals refer to the same parts throughout the various figures.

### DESCRIPTION OF THE PREFERRED EMBODIMENT

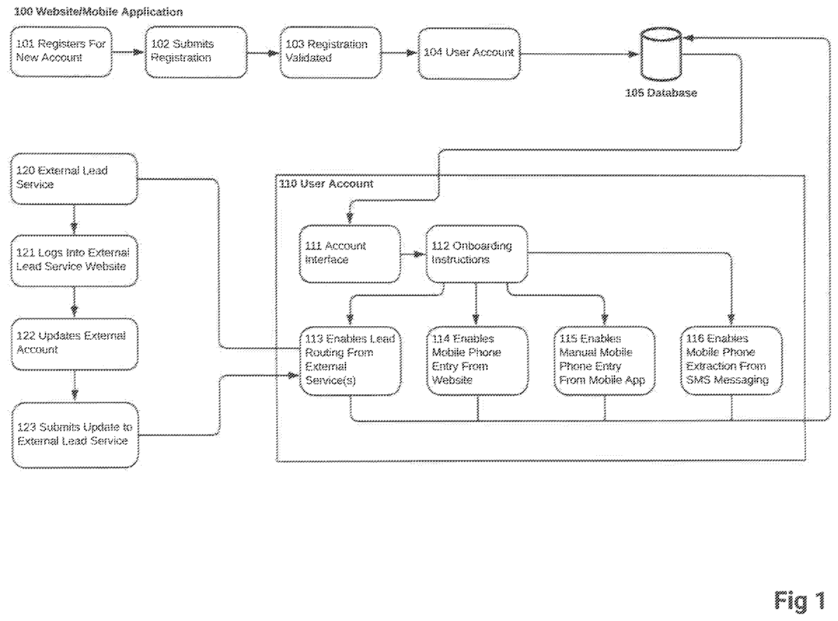

The drawings illustrate the invention, particular implementations of processes and methods of carrying out the invention. Referring now to the drawings, and particularly to FIG. 1, a preferred embodiment of the Method for Vetting a Lead Based Upon Numeric Databases of the present invention takes its form as a website/mobile application, as at 100. A business owner signs up for software application, or the present invention, online and downloads and installs software application, or the present invention, to mobile device and, when business owner is signed up with software application the software application, or the present invention, programmatically creates a unique email address and unique virtual phone number that is designated for the business owner's account within software application, or the present invention.

User then makes lead request communication to business owner via phone, email, in-person, or text and business owner opens the software application, or the present invention, with device screen and device keyboard or with device microphone and device speech translation mechanism on device. Once software application, or the present invention, is open or active on the device of business owner, the business owner manually inputs data to secure interface of software application, or the present invention, and data input is securely submitted then transmitted securely to server and software application, or the present invention, and database or the business owner utilizes outside website account on separate system software application on separate system server to update the separate system software application account email data with software application, or the present invention, generated, unique email address and then update the separate system software application account phone number data with software application, or the present invention, generated, unique virtual phone number on outside separate system website interface submitted to outside application database on outside separate server. Separate system software application will email SMTP server application securely on server when outside application generates lead then SMTP server application and/or SMS/MMS message will be sent to SMS/MMS gateway and data is securely submitted then transmitted securely to software application, or the present invention, and database or user securely enters data on website interface using device screen and device keyboard and submits data which is transmitted securely on internet to server and software application, or the present invention, and database then the software application, or the present invention, vetting process business logic is initiated and communicates via SMS/MMS message or email to the user to request information to vet their request and the software application, or the present invention, will automatically contact external data sources to look up additional information data based on user input from prior steps of this process. Once the user completes the software application, or the present invention, vetting process steps then the business owner will see vetting status within the software application, or the present invention.

More particularly, the method of the present invention in FIG. 1, in website or mobile app form as at 100, where a user, or business owner who leases the invention in software form, installs and sets up the invention on their electronic device of choice. The user registers for a new account, as at 101, and submits that registration request as at 102 to the invention. The invention then validates the registration of the user as at 103 and opens the users account as at 104. The invention maintains the user's account on its database shown as at 105.

The database also holds a user account 110 as part of the invention. The user account 110 has a virtual phone number and custom email for the user. The user, i.e., lessee of software, may choose to use the virtual phone number and custom email to function as a forwarding mechanism from outside lead services that do not offer automatic lead vetting as in the present invention.

Within the user account as at 110, the invention has further features beginning with an account interface as at 111 that provides onboarding instructions to the user reading them, as at 112. The onboarding instructions related to lead generation means. The instructions further specify that a user, i.e., a business owner lessee of software, who choose to use lead forwarding, to then to the third-party sites, log in there, and update the email address and phone number on those third-party accounts. A user, i.e., a business owner lessee of software, has the choice to enter bid/sales requests manually and to receive forwarded bid/sales leads from third party accounts into the invention for automated vetting.

After reading the instructions as at 112, a user may select a lead routing with external services as at 113. The user goes to the third-party website, as at 120, or external lead service, and logs into it as at 121. There the user updates the user's account with that third-party website as at 122 such as email address or other communication means to receive the lead information from the third-party website. The user then submits the update to the user's communication means to the third-party website as at 123. Then the present invention utilizes email servers that manage and receive an email message from the custom email address stored by the third-party website. The present invention programmatically saves email text content and extracts lead text. This choice by the user of the invention has a lead come from a third-party account or website.

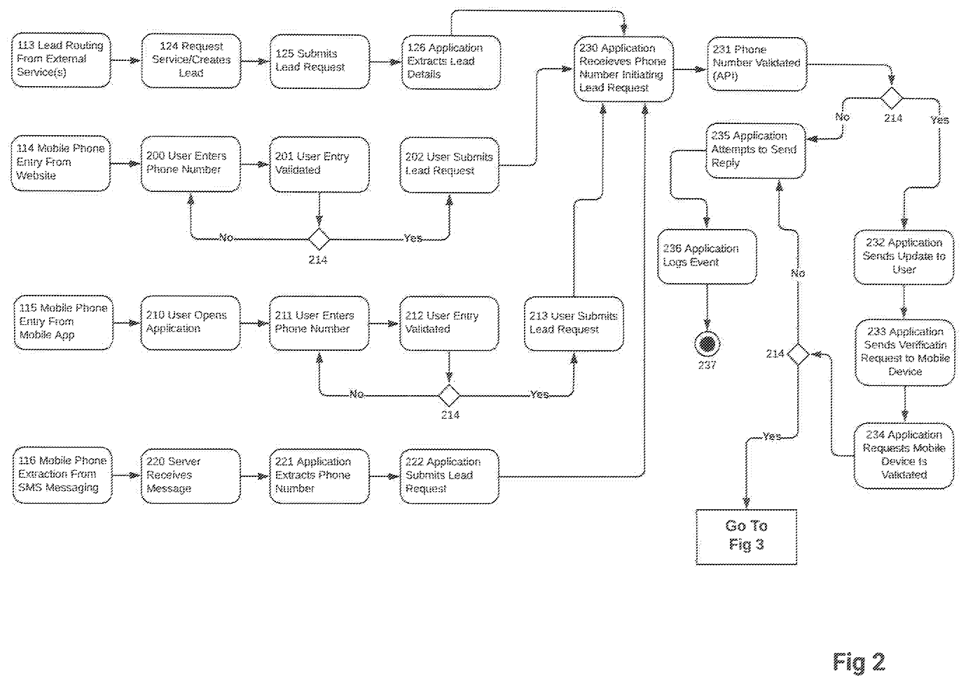

After reading the instructions as at 112, a user may select a lead from a public portion of the invention's website form, or more particularly a user or the public may enter a mobile phone number through a webpage of the invention, as at 114. Here, the user, i.e., business owner lessee of software, selects the website generated lead which comes from the user's own lead request webpage. An end customer, who requested a quote from the user, enters and submits his bid and sales lead information on the user's webpage. The present invention includes a server that collects website submissions and creates a new lead vetting request to start the lead as later shown in FIG. 2.

After reading the instructions as at 112, a user may select a lead from the user's, i.e., business owner lessee of software, manual lead. More particularly, a user may select a lead from a mobile phone number through the mobile application, or app, of the invention, as at 115. Here, the user, i.e., business owner lessee of software, enters a mobile phone number directly into the invention from the user's portable electronic device, such as a smartphone or table computer. The invention utilizes the mobile phone number to generate a lead which comes from the user's own lead request submitted over the mobile app. Also in this selection, the user enters the customer's phone number and zip/postal code into the software interface, see 111. As before, the customer requested a quote from the user. The user submits the customer's data into the present invention, or it receives a manually entered lead vetting submission. The present invention manages this request and creates a new lead vetting request to start the lead as later shown in FIG. 2.

And after reading the instructions as at 112, a user may select a lead from public texting, typically via SMS, as at 116. In this selection, the user collects leads via mobile phone numbers submitted as data in a text message. The present invention manages this request and creates a new lead vetting request to start the lead as later shown in FIG. 2.

From the FIG. 1 description, leads may start in various ways. FIG. 2 further describes generating a lead request beginning with a lead from external services, as at 113, as previously described but with renewed emphasis on mobile phone numbers. With that lead, a user then requests service or creating a lead as at 124. The user then requests the lead as at 125 from the invention that receives a phone number. The invention, such as its mobile app, extracts the details of a lead from a data source in database form as at 126. The application then initiates a lead request a at 230, upon receipt of a mobile phone number.

Following entry of a mobile phone number through a webpage of the invention, as at 114, a user may also directly enter a phone number 200 and have the invention validate the entered phone number as at 201. The invention then confirms the validity of the mobile phone number at a decision point as at 214. A negative decision on validity reverts the user to enter the phone number again as at 200. A positive decision on validity submits the lead request into the invention to initiate a lead request as at 230, upon receipt of a mobile phone number.

After a user opens his account, see 104 infra, and selects a lead from a mobile phone number through the mobile application, or app, of the invention, as at 115, the user opens the invention, in mobile app form, as at 210 upon the electronic device of his choice. There the user enters phone number as at 211 and the invention validates that phone number as at 212. The invention then confirms the validity of the phone number at a decision point as at 214. A negative decision on validity reverts the user to enter the phone number again as at 211. A positive decision on validity requests a lead as at 213 from the invention as at 230.

Related to public texting as at 116, the invention receives a message, typically in SMS format, as at 220. From there, the invention extracts a mobile phone number as at 221 and submits that phone number for validation, often through an API, or application programming interface. With a mobile phone number present in the invention, it requests a lead as at 222 from the invention as at 230.

In an alternate embodiment, the validation step of the method following extraction of a mobile phone number, as at 222, reaches a decision point about authenticity. A negative decision on authenticity activates a reply message sent to the sender. The present invention then logs the sending of the reply message and then closes, or returns the user to the account interface. While a positive decision on authenticity requests a lead from the invention.

Though four ways had description above, the Applicant foresees other ways to request leads. The previous four ways each result in the invention receiving a phone number to initiate a lead request as at 230. With a phone number stored, the invention then validates the mobile phone number using an API, or application programming interface, as at 231. The validation step, 231, leads to another decision point as at 214 to the right of the figure. A negative decision on validity has the invention attempt to send a reply, as in a text message, as at 235 to the mobile phone number. The present invention then logs the sending of the reply message, as at 236 and then closes as at 237.

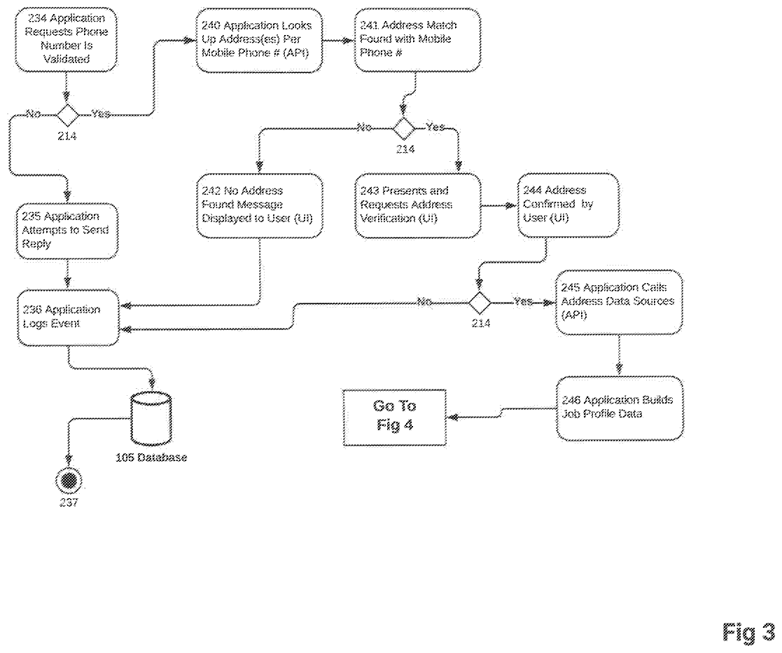

A positive decision on validity sends an update, as at 232, to the account of the user as at 110, thus informing the user of progress upon a lead. The invention then verifies the mobile phone number, as at 233, often using a verification request, such as a multi-factor authentication, or MFA. The application of the invention then requests the device of the mobile phone number to validate, such as by checking device serial number or SIM card number, as at 234. This device validation, 234, causes a decision point as at 214 to the lower right in the figure. A negative decision on validity has the invention attempt to send a reply, as in a text message, as at 235, to the mobile phone number and without a reply, the invention logs as at 236 and then closes as at 237, or returns to the interface 111. A positive decision on validity then moves the invention to FIG. 3.

In FIG. 3, from device validation as at 234 in the left of the figure, a negative decision on validation, has the invention send a reply message to the phone number at 235. The present invention then logs the sending of the reply message, as at 236, upon its database as at 105 and then closes as at 237, or returns the user to the account interface as at 111.

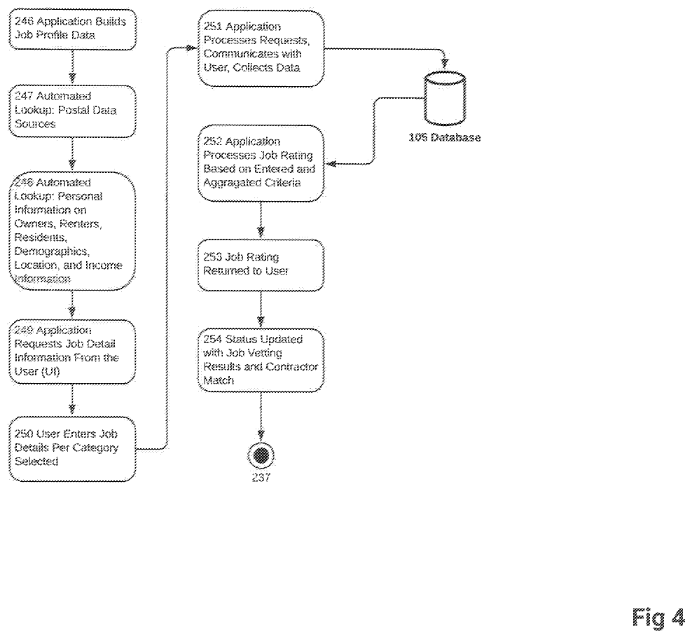

While a positive decision on validation moves the lead request forward where the invention collects or reviews addresses associated with the mobile phone number as at 240, often using an API. The invention then presents the collection of addresses matched to the mobile phone to the user for verification by the end customer, as at 241. This address matching, 241, causes a decision point as at 214 to the upper center in the figure. A negative decision on matching, that is, no addresses found has the invention log an event as at 236 and proceed from there as previously described. A positive decision on matching, then has the invention presents the collection of addresses to the user for verification, as at 243, such as through the user interface of 111, or UI. Another decision point comes about as at 244 to the lower center of the figure regarding address confirmation by the user. A negative decision on confirmation, that is, the user does not recognize the address found has the invention log an event as at 236 and proceed from there as described above. A positive decision on confirmation, then has the invention prompts the invention to call address data sources automatically as at 245 via a separate API. The invention then proceeds and builds a job data profile as at 246. This profile begins to match the lead with a loan, a project, or a task up for bid. The building of the job data profile proceeds as later shown in FIG. 4.

And we turn to FIG. 4 where the invention continues assembling the job data profile as at 246. The invention calls an address verification source as at 243. The invention and the source cooperatively perform an automated review of postal address data as at 247. The invention and the source again cooperatively perform an automated review of personal information about an owner, a mortgage payor, a tenant, a property owner, or a resident connected to an address and with demographic and econometric information, including income levels individually and within a census tract or zip code, as at 248. The invention then requests job detail information from the user, as at 249, often related to the address of a job/project. The user usually provides this through the interface 111. The invention continues with receiving user collected and assembled details of a job, such as square footage, elevation, special machinery, and the like, as at 250, by selected categories. As it operates, the invention processes requests, communicates internally, and collects data related to the address as at 251, and places the data upon the invention's database 105. The database then prompts the invention to prepare a job rating from that data and select criteria as at 252, including entered and aggregate criteria. The invention then provides that rating of the job profile, as at 253, to the user through the account interface 111. The invention then updates the status of its operation upon job vetting and contractor match, such as the user, as at 254, upon the user's account interface once more. The user then acts upon the information shown to him in the interface or closes the invention as at 237.

Software starts automated lead vetting, lead status in software is updated. Software contacts the customer (the person who requested a quote) to verify lead information, and the lead status in software is updated. Customer (the person who requested a quote) provides information based on lead type request, and the lead status in software is updated. Software automatically takes additional steps on its own to look up other public data that pertains to the lead request type; lead status in software is updated. Software builds a lead profile to score and rate the lead, finalizing the lead vetting process. The user (business owner lessee of software) is notified via email and text message. The user (business owner lessee of software) can also log into the web-based software to see an overview of lead vetting statuses. Based on settings set by the user (business owner lessee of software) in the software, the customer (the person who requested a quote) will receive automated updates to request additional steps to finalize the quote request, schedule a meeting, sign a contract, or additional tasks to accept the job for the user (business owner lessee of software).

The invention uses these steps. Once the user (business owner lessee of software) signs up for the software and downloads the application to their mobile device, they can input the phone number and zip/postal code of their potential customer to begin automatically vetting this sales lead. This software will manage this data input, submit the data, receive the lead vetting request, and perform automated interaction on behalf of the user (business owner lessee of software) with the potential customer who is requesting a quote or bid for work. The automated lead vetting process steps are designed based on the lead request type and the account type when the user (business owner lessee of software) signed up for the account. There are lead types and business types that are used to categorize and therefore more effectively vet the lead. While the customer (the person who requested a quote) completes the lead vetting process steps the user (business owner lessee of software) can see the status of this vetting process at any time. Once the vetting process has been completed by the customer (the person who requested a quote) the user (business owner lessee of software) will see a lead vetting score where they have software setting options to allow automated emails or texts to be sent to follow up with the lead vetting. In addition, the user (business owner lessee of software) has additional options for lead forwarding and to receive leads from their own website by using the virtual phone number and assigned email address they are given when signing up for the software. This allows the user (business owner lessee of software) to update other, third-party service account phone number and email data, on outside accounts and, when these outside accounts receive lead requests they will be forwarded for automatic lead vetting.

While a preferred embodiment of the Method for Vetting a Lead Based Upon Numeric Databases has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods, and systems for carrying out the several purposes of the present invention. Therefore, the claims include such equivalent constructions insofar as they do not depart from the spirit and the scope of the present invention.

I claim:

1. A method to compare at least two databases regarding information upon a lead, comprising:
providing at least two databases;
registering a user;
receiving data from the user;
submitting the data for processing;
receiving a request for lead verification from said user;
vetting a status of a lead;
providing the status of the vetting to the user;
calculating a vetting score;
organizing follow up for the vetting of a lead;
forwarding a lead to another user;
updating said at least two databases from said vetting the status of a lead; and
forwarding lead requests from said at least two databases to said vetting the status of a lead.

2. The method to compare at least two databases regarding information upon a lead of claim 1, further comprising:
said providing the status of the vetting to the user including an interface viewable by the user.

3. The method to compare at least two databases regarding information upon a lead of claim 2, further comprising:
said vetting a status of a lead including validating at least one data from the user.

4. The method to compare at least two databases regarding information upon a lead of claim 3, further comprising:
said receiving a request for lead verification from said user including a mobile phone number.

5. The method to compare at least two databases regarding information upon a lead of claim 4, further comprising:
said receiving a request for lead verification from said user including validating the mobile phone number; and
wherein an invalid mobile phone number prompts said receiving a request for lead verification from said user to reply to the mobile phone number.

6. The method to compare at least two databases regarding information upon a lead of claim 4, further comprising:
said receiving a request for lead verification from said user including validating the mobile phone number;
wherein a valid mobile phone number prompts said receiving a request for lead verification from said user to verify a postal address and to verify ownership status;
said verifying a postal address cooperatively communicates with a database of postal addresses; and
said ownership status cooperatively communicates with a database of land records.

7. The method to compare at least two databases regarding information upon a lead of claim 4, further comprising:
said receiving a request for lead verification from said user is adapted to utilize an electronic device of said user.

8. The method to compare at least two databases regarding information upon a lead of claim 6, further comprising:
building job profile data, including cooperatively communicating with a database of job details and collecting job profile data;
said calculating a vetting score then occurs;
said providing the status of the vetting to the user including an interface viewable by the user; and
refreshing said interface viewable by the user.
